(19) United States
(12) Patent Application Publication
(10) Pub. No.: US 2020/0213453 A1
(43) Pub. Date: Jul. 2, 2020

(54) IMAGE FORMING APPARATUS CAPABLE OF GENERATING FAILURE REPORT AND OPERATING METHOD THEREOF

(71) Applicant: HEWLETT-PACKARD DEVELOPMENT COMPANY, L.P., Spring, TX (US)

(72) Inventor: Sang Hyun PARK, Pangyo (KR)

(73) Assignee: HEWLETT-PACKARD DEVELOPMENT COMPANY, L.P., Spring, TX (US)

(21) Appl. No.: 16/628,606

(22) PCT Filed: Jul. 9, 2018
(86) PCT No.: PCT/KR2018/007732

§ 371 Date: Jan. 3, 2020

(30) Foreign Application Priority Data
Jul. 18, 2017 (KR) 10-2017-0091061

(51) Int. Cl. H04N 1/00; G06F 11/30; G06F 11/34

(52) U.S. Cl. CPC H04N 1/00061; H04N 1/00395; G06F 11/3476; H04N 1/00411; G06F 11/3013; H04N 1/00079

(57) ABSTRACT

An image forming apparatus capable of generating a failure report and an operating method of the image forming apparatus are provided. In an example, the image forming apparatus is capable of obtaining, from a user, information about a failure of the image forming apparatus that is undetectable by the image forming apparatus and reporting the failure, based on the obtained information about the failure of the image forming apparatus.

### BACKGROUND ART

The disclosure relates to image forming apparatuses capable of generating a failure report and operating methods thereof. More particularly, the present disclosure relates to an image forming apparatus capable of reporting a failure thereof, based on information about the failure obtained from a user, and an operating method of the image forming apparatus.

When an image forming apparatus detects a failure thereof, the failure may be reported to a server via a screen of the image forming apparatus, a mobile terminal of a user, or another device. However, when a failure that the image forming apparatus cannot sense occurs, a user needs to phone a service center or send an inquiry to a service website in order to address the failure. Because the information that can be delivered to the service center or the service website by the user, who is a non-professional user, is limited, feedback to address the failure may not be effectively provided.

### DISCLOSURE

### Description of Drawings

The above and other aspects, features, and advantages of certain examples of the disclosure will be more apparent from the following description taken in conjunction with the accompanying drawings, in which:

FIG. 1 is a diagram illustrating a failure report and feedback process performed by an image forming apparatus according to an example;

FIG. 2 is a block diagram of a structure of an image forming apparatus according to an example;

FIG. 3 is a block diagram illustrating a relationship between an image forming apparatus, an external apparatus, and a server according to an example;

FIG. 4 is a block diagram of a structure of an image forming apparatus according to another example;

FIG. 5 is a block diagram of a structure of a controller according to an example;

FIG. 6 is a flowchart of an operating method of an image forming apparatus according to an example;

FIG. 7 is a flowchart of a first reporting method according to an example;

FIG. 8 is a flowchart of a second reporting method according to an example;

FIG. 9 is a flowchart illustrating operations of a user, an image forming apparatus, a server, and a technician when a first reporting method is performed according to an example;

FIG. 10 is a flowchart illustrating operations of a user, an image forming apparatus, a server, and a technician when a second reporting method is performed according to an example;

FIG. 11 illustrates user interface (UI) screen images that show a failure reporting process according to an example;

FIG. 12 illustrates UI screen images that display a failure countermeasure according to an example;

FIG. 13 illustrates a UI screen image of a server according to an example;

FIG. 14 illustrates an example in which a server analyzes information about a failure input by a user, based on keywords;

FIGS. 15A and 15B are tables illustrating an example in which a server analyzes a log pattern included in history information of an image forming apparatus;

FIG. 16 illustrates a result obtained by a server analyzing a failure of an image forming apparatus according to an example; and

FIG. 17 illustrates an example in which a server transmits a failure handling method.

Throughout the drawings, like reference numerals will be understood to refer to the same or similar elements, features, parts, components, and structures.

### MODE FOR INVENTION

Various examples now will be described more fully hereinafter with reference to the accompanying drawings. The examples described hereinafter may be modified in many different forms. To more clearly describe features of examples, matters well known to one of ordinary skill in the art to which the below examples pertain will not be described in detail.

Throughout the specification, when an element is referred to as being “connected” or “coupled” to another element, it can be directly connected or coupled to the other element, or can be connected or coupled to the other element with intervening elements interposed therebetween. In addition, the terms “comprises” and/or “comprising” or “includes” and/or “including” when used in this specification, specify the presence of stated elements, but do not preclude the presence or addition of one or more other elements.

In the specification, an “image forming job” may denote any one of various jobs (e.g., printing, scanning, copying, or faxing) related to an image, such as forming of an image or generating/storing/transmitting of an image file, and a “job” may denote not only an image forming job, but may also denote a series of processes required to perform the image forming job.

An “image forming apparatus” may denote any apparatus capable of performing an image forming job, such as a printer, a scanner, a fax machine, a multi-function printer (MFP), a display apparatus, or the like.

A “hard copy” may denote an operation of printing an image on a print medium, such as a paper, and a “soft copy” may denote an operation of printing an image on a display device, such as a television (TV) or a monitor, or saving an image to a memory.

“Content” may denote any type of data that is a target of an image forming job, such as a picture, an image, a document file, or the like.

“Print data” may denote data having a format printable by a printer.

A “scan file” may denote a file generated by scanning an image by using a scanner.

A “user” may denote a person who performs manipulation related to an image forming job by using an image forming apparatus or a device connected to the image forming apparatus wirelessly or via wires. A “manager” may denote a person who has authority to access all functions and a system of an image forming apparatus. A “manager” and a “user” may be the same person.

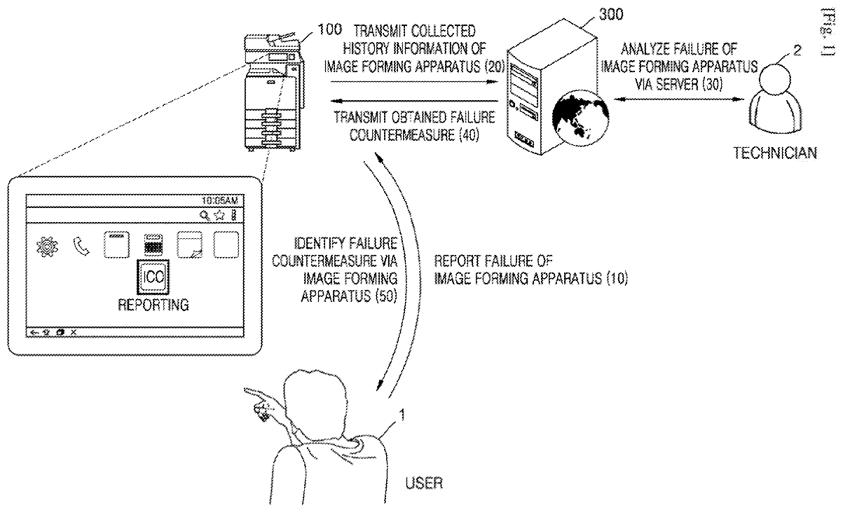

FIG. 1 is a diagram illustrating a failure report and feedback process performed by an image forming apparatus according to an example.

Referring to FIG. 1, a “failure” may denote a state in which a device does not normally operate or a state in which an apparatus does not operate as desired by a user 1. The failure may include a software failure, a hardware failure, or both. The failure may include a case where an apparatus malfunctions even when the user 1 properly manipulates the apparatus, a case where the user 1 does not properly manipulate an apparatus and thus the apparatus malfunctions, and a case where an apparatus properly operates but the user 1 wrongly considers that the apparatus has a problem. The terminology “failure” used herein is a general term that indicates, but is not limited to, a disorder, a malfunction, a mistake, an error, a problem, or a defect.

During generation of a failure report and feedback process of an image forming apparatus 100 according to an example, when the user 1 inputs information to report a failure of the image forming apparatus 100 in operation 10, the image forming apparatus 100 may collect history information of the image forming apparatus 100 and transmit the collected history information to a server 300 in operation 20. A technician 2 may analyze the failure of the image forming apparatus 100 via the server 300 in operation 30. The server 300 may obtain a failure countermeasure from the technician 2 and transmit the obtained failure countermeasure to the image forming apparatus 100 in operation 40, and the user 1 may receive the failure countermeasure via the image forming apparatus 100 in operation 50.

According to an example, the report of the user 1 may be a trigger to instruct the image forming apparatus 100 to collect history information. When the user 1 detects a failure and sends a failure report to the image forming apparatus 100 while the image forming apparatus 100 is not detecting the failure, the image forming apparatus 100 starts to collect history information that may be used to ascertain the failure.

Even when the image forming apparatus 100 does not sense a failure thereof, the image forming apparatus 100 may perform a process of reporting a failure thereof, based on information about the failure obtained from the user 1. Accordingly, when the image forming apparatus 100 is used, the accuracy and convenience of reporting the failure may increase, compared with a case where, when a failure undetectable by an image forming apparatus occurs, the user 1 personally informs a service center or a service website of the failure.

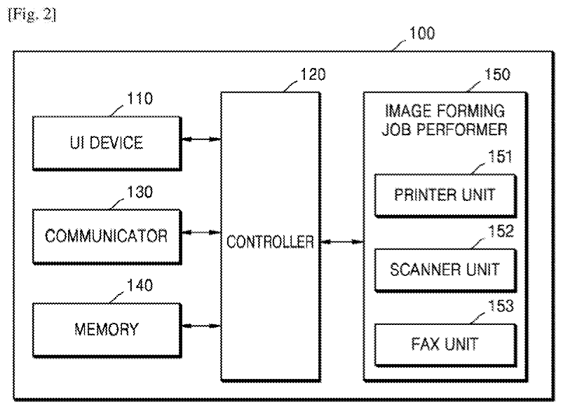

FIG. 2 is a block diagram of a structure of an image forming apparatus according to an example.

Referring to FIG. 2, the image forming apparatus 100 may include a user interface (UI) device 110, a controller 120, a communicator 130, a memory 140, and an image forming job performer 150. Although not shown in FIG. 1, the image forming apparatus 100 may further include a power supply for supplying power to each component of the image forming apparatus 100.

The UI device 110 may include an input unit for receiving, from a user, an input for performing an image forming job, and an output unit for displaying information, such as a result of performing an image forming job or a state of the image forming apparatus 100. In an example, the UI device 110 may include an operation panel that receives a user input, and a display panel that displays a screen image.

The input unit may include at least one of devices capable of receiving various types of user inputs, such as a keyboard, a physical button, a touch screen, a camera, a microphone, or the like. The output unit may include, but is not limited thereto, a display panel, a speaker, or the like. However, the UI device 110 may include another device that supports various inputs and outputs.

The UI device 110 of FIG. 2 may include an independent control system. In an example, the UI device 110 of FIG. 2 may include a control system (e.g., a controller and a memory) for controlling a UI provided by the UI device 110, separate from the controller 120 of the image forming apparatus 100. An operating system (OS) for providing a UI, and programs, such as an application for supporting various functions, may be installed in the control system of the UI device 110.

The UI device 110 may obtain information about a failure of the image forming apparatus 100 that is undetectable by the image forming apparatus 100, according to an input of the user 1.

According to an example, the failure of the image forming apparatus 100 that is undetectable by the image forming apparatus 100 may include a hardware failure of the image forming apparatus 100, subjective discomfort felt by the user 1 of the image forming apparatus 100, a software failure not experienced by the image forming apparatus 100, a software failure not experienced by the server 300, or the like.

The hardware failure of the image forming apparatus 100 may be, as an example, a case where a wired connection between the image forming apparatus 100 and an external apparatus, such as a personal computer (PC), is wrong, a case where a portion of the last paper sheet of an output document is always output in a blurred stated, etc. The subjective discomfort felt by the user 1 of the image forming apparatus 100 may be, in an example, a case where there is a difference between a brightness of a document initially output by the image forming apparatus 100 and a brightness of a document recently output by the image forming apparatus 100, or a case where an output speed of the image forming apparatus 100 is reduced compared with an output speed at the beginning of use of the image forming apparatus 100. The software failure not experienced by the image forming apparatus 100 or the server 300 may be, in an example, a case where an operating speed of the image forming apparatus 100 is reduced due to a software virus.

According to an example, when a failure not detected by the image forming apparatus 100 is detected by the user 1, the user 1 may input information about the detected failure to the image forming apparatus 100.

The controller 120 may control overall operations of the image forming apparatus 100, and may include a processor, such as a central processing unit (CPU). The controller 120 may control other components included in the image forming apparatus 100 such that an operation corresponding to a user input received via the UI device 110 is performed.

In an example, the controller 120 may execute a program stored in the memory 140, read a file stored in the memory 140, or store a new file in the memory 140.

The controller 120 may collect history information of the image forming apparatus 100, based on the information about the failure of the image forming apparatus 100.

According to an example, the history information of the image forming apparatus 100 may include a log record, a UI manipulation history, network information of the image forming apparatus 100, or the like.

The communicator 130 may perform wired/wireless communication with another device or a network. To this end, the communicator 130 may include a communication module that supports at least one of various wired and wireless communication methods. In an example, the communication module may be in the form of a chipset, or may be a sticker or barcode (e.g., a sticker including a near field communication (NFC) tag) including information necessary for communication.

The wireless communication may include, in an example, but is not limited thereto, at least one of wireless fidelity (WiFi), WiFi Direct, Bluetooth, ultra wide band (UWB), and NFC. The wired communication may include at least one of a USB and a high definition multimedia interface (HDMI).

Alternatively, the communicator 130 may communicate with the server 300 via a network protocol, such as https, Web Distributed Authoring and Versioning (WebDAV), FTP, SMTP, or the like.

The communicator 130 may be connected to an external apparatus outside the image forming apparatus 100 to transmit or receive a signal or data to or from the external apparatus. As an example, the image forming apparatus 100 may be connected to an external apparatus via the communicator 130. The communicator 130 may transmit a signal or data received from the external apparatus to the controller 120, or transmit a signal or data generated by the controller 120 to the external apparatus. In an example, when the communicator 130 receives a print command signal or print data from the external apparatus, the controller 120 may output the received print data through a printer unit 151.

The communicator 130 may transmit the information about the failure of the image forming apparatus 100 and the collected history information of the image forming apparatus 100 to the server 300. To minimize data loss and network traffic that may occur while transmitting a log included in the history information of the image forming apparatus 100 to the server 300, the communicator 130 may compress the log and transmit the compressed log to the server 300.

The communicator 130 may receive a failure countermeasure of the image forming apparatus 100 from the server 300. In more detail, the communicator 130 may receive the failure countermeasure, a failure management number, and a failure analysis result of the image forming apparatus 100 from the server 300.

According to an example, the “failure analysis result” may be a result obtained by the technician 2 analyzing a current failure of the image forming apparatus 100, based on the information about the failure of the image forming apparatus 100 and the history information of the image forming apparatus 100. The technician 2 may input, to the server 300, a “failure countermeasure” that may be taken with respect to the current failure of the image forming apparatus 100 by the user 1 based on the failure analysis result.

According to an example, the server 300 may generate a failure management number corresponding to the failure of the image forming apparatus 100, in response to the reception of the information about the failure and the history information of the image forming apparatus 100 from the image forming apparatus 100. The image forming apparatus 100 may receive the failure management number generated by the server 300, from the server 300.

The memory 140 may store programs installed thereon, such as applications, and various types of data, such as files. The controller 120 may access and use data stored in the memory 140 or may store new data in the memory 140. The controller 120 may execute a program installed in the memory 140. The controller 120 may install, in the memory 140, an application received from an external source through the communicator 130.

The image forming job performer 150 may perform an image forming job, such as printing, scanning, copying, or faxing.

Referring to FIG. 2, the image forming job performer 150 includes the printer unit 151, a scanner unit 152, and a fax unit 153. However, as occasion demands, the image forming job performer 150 may include some of them or may further include a component for performing another type of image forming job.

The printer unit 151 may form an image on a recording medium via any one of various printing methods, such as an electrophotography method, an inkjet method, a thermal transfer method, a thermal method, or the like.

The scanner unit 152 may irradiate light onto paper and receive light reflected from the paper on an image sensor to read an image recorded on the paper. Examples of an image sensor for reading an image from paper include a charge-coupled device (CCD) and a contact type image sensor (CIS). The scanner unit 152 may have a flatbed structure in which paper is located at a fixed location and an image sensor moves to read an image, a document feed structure in which an image sensor is located at a fixed location and paper is transferred, or a combination structure thereof.

The fax unit 153 may share a component for scanning an image with the scanner unit 152, share a component for printing a received file with the printer unit 151, transmit a scan file to a destination, or receive a file from an external source.

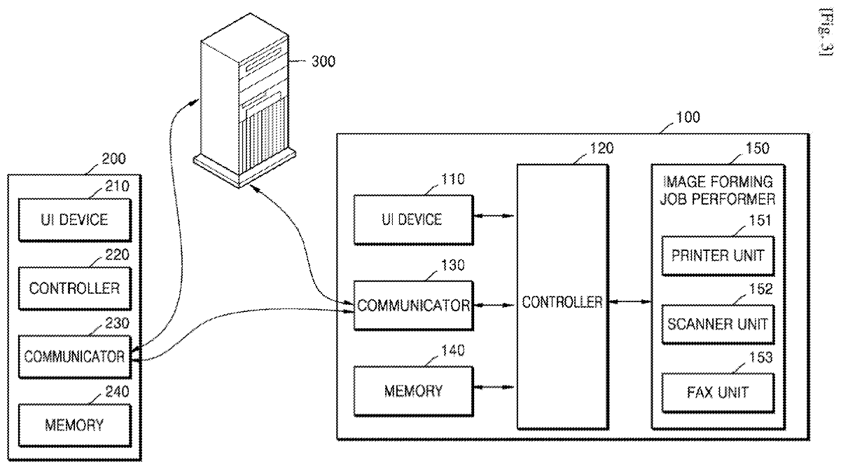

FIG. 3 is a block diagram illustrating a relationship between an image forming apparatus, an external apparatus, and a server according to an example.

Referring to FIG. 3, an external apparatus 200 may include a UI device 210, a controller 220, a communicator 230, and a memory 240. The controller 220 may control an image forming job by executing a program stored in the memory 240 and transmitting a signal or data generated as a result of executing the program to the image forming apparatus 100 through the communicator 230. The external apparatus 200 may include, for example, a smartphone, a tablet, a PC, a home appliance, a camera, a wearable device, or the like.

The communicator 130 may be directly connected to the server 300 to transmit or receive a signal or data to or from the server 300. The communicator 130 may be connected to the external apparatus 200 via the server 300. In other words, the communicator 130 of the image forming apparatus 100 may transmit or receive a signal or data to or from the communicator 230 of the external apparatus 200 via the server 300.

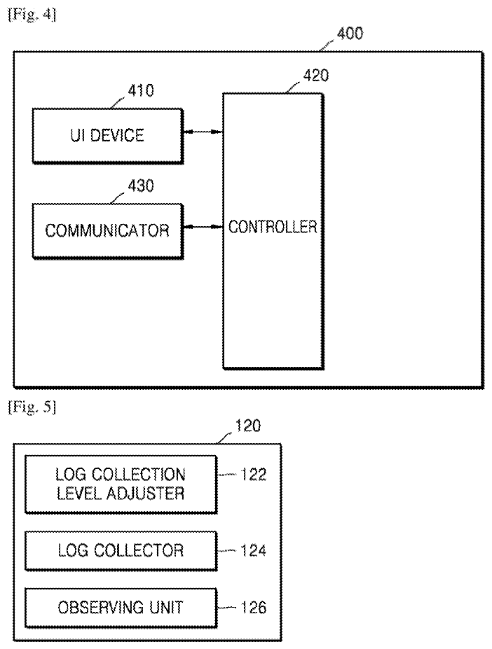

FIG. 4 is a block diagram of a structure of an image forming apparatus according to another example.

Referring to FIG. 4, an image forming apparatus 400 may include a UI device 410, a controller 420, and a communicator 430. It will be understood by one of ordinary skill in the art that the UI device 410 may perform the same operation as the UI device 110 of FIG. 2, the controller 420 may perform the same operation as the controller 120 of FIG. 2, and the communicator 430 may perform the same operation as the communicator 130 of FIG. 2.

A failure reporting method of the image forming apparatus 400 may include a first reporting method or a second reporting method. The first reporting method may denote a process in which the user 1 who sensed a failure of the image forming apparatus 400 inputs information such as details of the failure of the image forming apparatus 400 and an occurrence time of the failure of the image forming apparatus 400. The second reporting method may denote a process in which the user 1 makes a failure of the image forming apparatus 400 reappear while the image forming apparatus 400 is collecting its history information, such that the image forming apparatus 400 may easily collect history information related to the failure of the image forming apparatus 400.

When the user 1 uses the first reporting method, the user 1 is able to simply report a failure by inputting only the information such as details of the failure and an occurrence time point of the failure. However, compared with when the user 1 uses the second reporting method, the user 1 needs to write the information of the failure of the image forming apparatus 400 in enough detail in order to help the technician 2 to analyze the failure of the image forming apparatus 400. In addition, when the user 1 uses the first reporting method, the user 1 needs to input the occurrence time point of the failure in more detail.

When the user 1 uses the second reporting method, the failure of the image forming apparatus 400 reappears while the image forming apparatus 400 is collecting the history information, and thus, compared with the first reporting method, the failure of the image forming apparatus 400 may be more concretely and accurately ascertained.

The UI device 410 may obtain information about a failure of the image forming apparatus 400 that is undetectable by the image forming apparatus 400, according to an input of the user 1.

According to the first reporting method, the UI device 410 may obtain the information of the failure of the image forming apparatus 400 and the occurrence time point of the failure thereof from the user 1. The information of the failure of the image forming apparatus 400 may include details such as the name, characteristics, and the like of the failure. For example, the user may input “Name of failure: Increase in output standby time”, and “Characteristics of failure: Output standby time abnormally increases when a large-capacity document is output”, as the information of the failure of the image forming apparatus 100.

According to the second reporting method, the UI device 410 may obtain, from the user 1, an input for collecting the history information of the image forming apparatus 400. For example, when the user 1 touches or clicks an icon such as “second report” on a screen of the UI device 410, the UI device 410 may determine that an input for collecting the history information of the image forming apparatus 400 has been obtained.

The UI device 410 may obtain, from the user 1, an input for making a failure reappear. In more detail, while the image forming apparatus 400 is collecting the history information, the user 1 may allow the failure of the image forming apparatus 400 to reappear. For example, when a failure in which an output standby time abnormally increases occurs when the image forming apparatus 400 outputs a large-capacity document, the user 1 may make the failure of the image forming apparatus 400 reappear by outputting a large-capacity document while the image forming apparatus 400 is collecting the history information.

The UI device 410 may also obtain a comment about the failure from the user 1. In more detail, the UI device 410 may obtain a comment about the failure from the user 1, in response to the reappearance of the failure of the image forming apparatus 400 based on the input for making a failure reappear. The comment about the failure may include, for example, the name of the failure, the characteristics of the failure, an additional opinion of the user 1, or the like. When the user 1 inputs the comment about the failure according to the second reporting method, the user 1 may write the comment more briefly than when the user 1 inputs the information of the failure according to the first reporting method.

The controller 420 may collect history information of the image forming apparatus 400, based on information about a failure of the image forming apparatus 400.

According to the first reporting method, the controller 420 may collect the history information of the image forming apparatus 400, based on the information of the failure of the image forming apparatus 400 and the occurrence time point of the failure thereof obtained from the user 1.

According to the second reporting method, the controller 420 may up-adjust the collection level of the log in response to starting of the input of making a failure reappear. In more detail, the controller 420 may up-adjust the collection level of the log and start collecting the history information of the image forming apparatus 400, in response to the obtainment of, from the user 1, the input for collecting the history information of the image forming apparatus 400.

The controller 420 may collect the history information of the image forming apparatus 100, between a time point when the input for collecting the history information of the image forming apparatus 400 is obtained and a time point when an input for transmitting the history information of the image forming apparatus 400 to the server 300 is obtained.

The controller 420 may control the failure management number, the failure analysis result, and the failure countermeasure received from the server 300 to be matched with each other and displayed on the image forming apparatus 400. For example, when the user 1 touches a certain failure management number, at least one of a failure analysis result or a failure countermeasure corresponding to the specific failure management number may be displayed on the screen of the UI device 410.

The communicator 430 may transmit the information about the failure of the image forming apparatus 400 and the collected history information of the image forming apparatus 400 to the server 300. In more detail, the communicator 430 may transmit the occurrence time point of the failure thereof, and the collected history information of the image forming apparatus 400 to the server 300.

The communicator 430 may receive a failure countermeasure of the image forming apparatus 400 from the server 300. In more detail, the communicator 430 may receive a failure management number, a failure analysis result, and a failure countermeasure of the image forming apparatus 400 from the server 300.

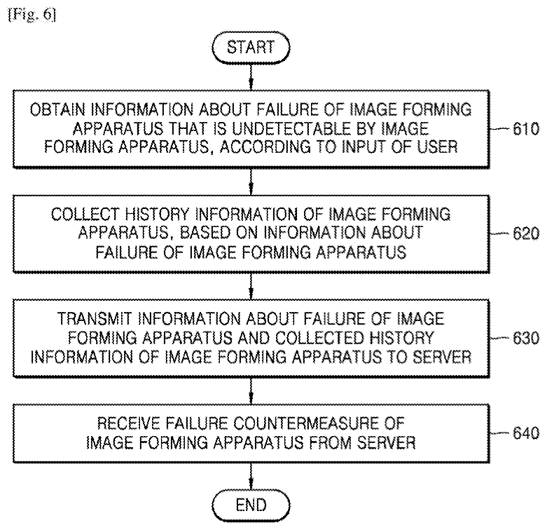

FIG. 5 is a block diagram of a structure of a controller according to an example.

Referring to FIG. 5, the controller 120 may include a log collection level adjuster 122, a log collector 124, and an observing unit 126.

The image forming apparatus 100 may collect the history information of the image forming apparatus 100 in order to report a failure to the server 300. A log may be an example of the history information of the image forming apparatus 100. A log is information that records an event that internally or externally occurs while a device is operating, processing information of the event, a status of the device, and job processing histories of the device. In an example, a log collection level of the image forming apparatus 100 may include three stages of “None”, “Job Status”, and “Info”.

According to an example, when the log collection level is the “None” stage, the image forming apparatus 100 may not record any information in the log. When the log collection level is the “Job Status” stage, the image forming apparatus 100 may record a status, an event, a job history of the image forming apparatus 100, or the like in the log. When the log collection level is the “Info” stage, the image forming apparatus 100 may record, in the log, a status of the image forming apparatus 100, a processing operation with respect to the status of the image forming apparatus 100, an event of the image forming apparatus 100, an operation for controlling the event, a job history of the image forming apparatus 100, a detailed setting value of the job history, or the like.

The log collection level adjuster 122 may adjust the log collection level of the image forming apparatus 100. The log collection level adjuster 122 may set the log collection level to be the “Job Status” stage in a normal situation, and, when more history information of the image forming apparatus 100 needs to be collected, the log collection level adjuster 122 may set the log collection level to the “Info” stage.

In an example, when the history information of the image forming apparatus 100 is collected according to the first reporting method, the log collection level adjuster 122 may set the log collection level to be the “Job Status” stage.

For another example, when the history information of the image forming apparatus 100 is collected according to the second reporting method, the log collection level adjuster 122 may up-adjust the log collection level to be the “Info” stage, in response to the obtainment of the input of the user 1 for collecting the history information by the UI device 110.

When the history information of the image forming apparatus 100 is collected according to the second reporting method, the log collection level adjuster 122 may adjust the log collection level back to be the “Job Status” stage, in response to the obtainment of, by the UI device 110, the input of the user 1 for transmitting the history information to the server 300. According to the second reporting method, the input for transmitting the history information of the image forming apparatus 100 to the server 300 may be obtained from the user 1 in response to the reappearance of the failure of the image forming apparatus 100 by the user 1.

The log collector 124 may record a log according to a log collection level defined by the log collection level adjuster 122. When the capacity of the log collector 124 exceeds a predetermined threshold, the log recorded in the log collector 124 may be deleted from the log collector 124 in an order from earliest recorded log to most recently recorded log.

The observing unit 126 may collect a UI manipulation screen recorded image or network information, which is the history information of the image forming apparatus 100. In more detail, the observing unit 126 may store an image of a UI manipulation screen whenever the UI manipulation screen changes, and may produce a moving picture, based on the stored images of the UI manipulation screens. The observing unit 126 may also store network data that is transmitted or received by the communicator 130 to or from outside of the image forming apparatus 100, such as in a packet capture (pcap) file structure.

The block diagrams of the image forming apparatuses 100 and 400, the external apparatus 200, and the controller 120 shown in FIGS. 2 through 5 are merely examples. Components illustrated in FIGS. 2 through 5 may be combined or omitted according to the specifications of apparatuses when being actually implemented, or additional components may be included in the block diagrams of FIGS. 2 through 5. In other words, two or more components may be combined into a single component, or a single component may be divided into two or more components. A function performed in each block is merely an example for explanation, and a detailed operation or device of each block does not limit the scope of the disclosure.

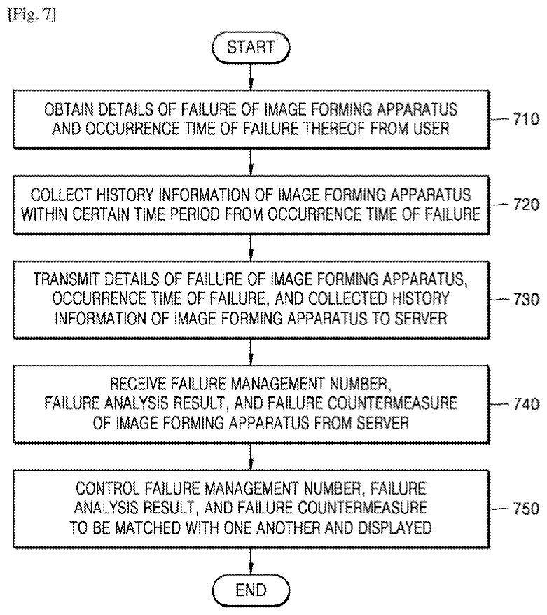

FIG. 6 is a flowchart of a method of operating an image forming apparatus according to an example.

Each operation of the method of FIG. 6 may be performed by the components of the image forming apparatuses 100 and 400 of FIGS. 2 through 5, and a repeated description of matters described above with reference to FIGS. 2 through 5 is omitted herein.

Referring to FIG. 6, the image forming apparatus 100 may obtain information about a failure of the image forming apparatus 100 that is undetectable by the image forming apparatus 100, according to an input of the user 1 in operation 610.

According to an example, the image forming apparatus 100 may obtain information such as details of the failure of the image forming apparatus 100 and an occurrence time point of the failure from the user 1.

Alternatively, the image forming apparatus 100 may obtain, from the user 1, an input for collecting the history information of the image forming apparatus 100. The image forming apparatus 100 may also obtain, from the user 1, an input of making a failure reappear. The image forming apparatus 100 may also obtain a comment about the failure from the user 1.

In operation 620, the image forming apparatus 100 may collect the history information of the image forming apparatus 100, based on the information about the failure of the image forming apparatus 100.

According to an example, the image forming apparatus 100 may collect the history information thereof within a certain time period from the occurrence time of the failure.

Alternatively, in response to the starting of the input of the user 1 for making the failure reappear, the image forming apparatus 100 may up-adjust the collection level of the log and start collecting the history information of the image forming apparatus 100.

In operation 630, the image forming apparatus 100 may transmit the information about the failure of the image forming apparatus 100 and the collected history information of the image forming apparatus 100 to the server 300.

According to an example, the image forming apparatus 100 may transmit the information such as details of the failure of the image forming apparatus 100, the occurrence time point of the failure, and the collected history information of the image forming apparatus 100 to the server 300.

Alternatively, the image forming apparatus 100 may transmit the comment about the failure obtained from the user 1 and the collected history information of the image forming apparatus 100 to the server 300.

According to an example, the server 300 may analyze the failure of the image forming apparatus 100, based on the information about the failure of the image forming apparatus 100 and the collected history information of the image forming apparatus 100 received from the image forming apparatus 100. When, as a result of the analysis performed by the server 300, a failure countermeasure to address the failure of the image forming apparatus 100 is detectable by the server 300, the server 300 may immediately transmit the failure countermeasure to the image forming apparatus 100.

Alternatively, when, as a result of the analysis performed by the server 300, a failure countermeasure to address the failure of the image forming apparatus 100 is undetectable by the server 300, the server 300 may transmit the information about the failure of the image forming apparatus 100 and the collected history information of the image forming apparatus 100 to the technician 2. The technician 2 may generate a failure analysis result and a failure countermeasure of the image forming apparatus 100, based on the information about the failure of the image forming apparatus 100 and the collected history information of the image forming apparatus 100. The technician 2 may input the failure analysis result and the failure countermeasure of the image forming apparatus 100 to the server 300. The server 300 may store, in a memory, the failure analysis result and the failure countermeasure of the image forming apparatus 100 obtained from the technician 2. The failure analysis result and the failure countermeasure stored in the memory may be used when a similar failure is reported to the server 300 later.

According to an example, after the transmission of the information about the failure of the image forming apparatus 100 and the collected history information of the image forming apparatus 100 to the server 300 is completed, the image forming apparatus 100 may request the server 300 for a failure management number corresponding to the failure of the image forming apparatus 100.

In operation 640, the image forming apparatus 100 may receive the failure countermeasure of the image forming apparatus 100 from the server 300.

According to an example, the image forming apparatus 100 may receive the failure management number, the failure analysis result, and the failure countermeasure of the image forming apparatus 100 from the server 300.

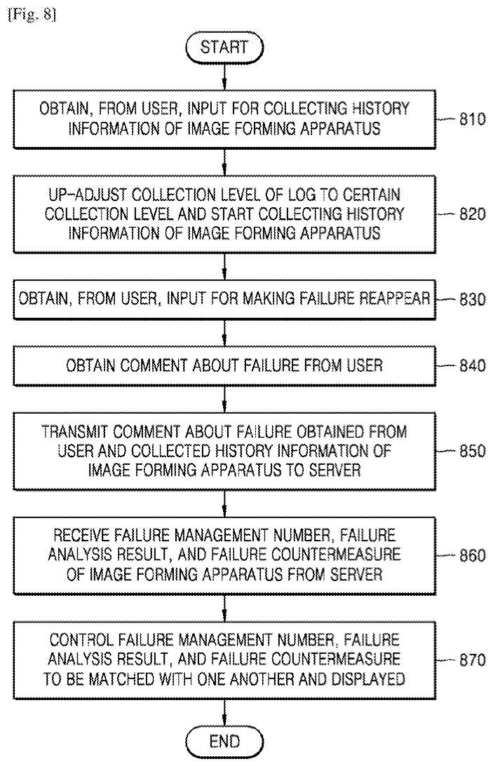

FIG. 7 is a flowchart of a first reporting method according to an example.

Operation 710 of FIG. 7 may be a portion of operation 610 of FIG. 6, operation 720 of FIG. 7 may be a portion of operation 620 of FIG. 6, operation 730 of FIG. 7 may be a portion of operation 630 of FIG. 6, and operation 740 of FIG. 7 may be a portion of operation 640 of FIG. 6.

Referring to FIG. 7, the image forming apparatus 100 may obtain information such as the details of the failure of the image forming apparatus 100 and the occurrence time point of the failure thereof from the user 1 in operation 710.

In operation 720, the image forming apparatus 100 may collect the history information thereof within a certain time period from the occurrence time of the failure. In an example, the image forming apparatus 100 may collect at least one of the log, the UI manipulation screen recorded image, and the network information of the image forming apparatus 100 within a certain time period from the occurrence time of the failure.

For example, when the failure of the image forming apparatus 100 occurred at around 2 p.m. on Jul. 11, 2017 and a certain time range preset in the image forming apparatus 100 is 2 hours, the image forming apparatus 100 may collect history information of the image forming apparatus 100 between 1 p.m. and 3 p.m. on Jul. 11, 2017.

In operation 730, the image forming apparatus 100 may transmit the information such as the details of the failure of the image forming apparatus 100, the occurrence time point of the failure, and the collected history information of the image forming apparatus 100 to the server 300.

In operation 740, the image forming apparatus 100 may receive the failure management number, the failure analysis result, the failure countermeasure of the image forming apparatus 100, or the like from the server 300.

According to an example, the server 300 may transmit the failure management number, the failure analysis result, the failure countermeasure, or the like to the image forming apparatus 100, by using an internet protocol (IP) address, a MAC address, a host name, a manufacturing number, and the like.

In operation 750, the image forming apparatus 100 may control the failure management number, the failure analysis result, and the failure countermeasure to be matched with one another and displayed.

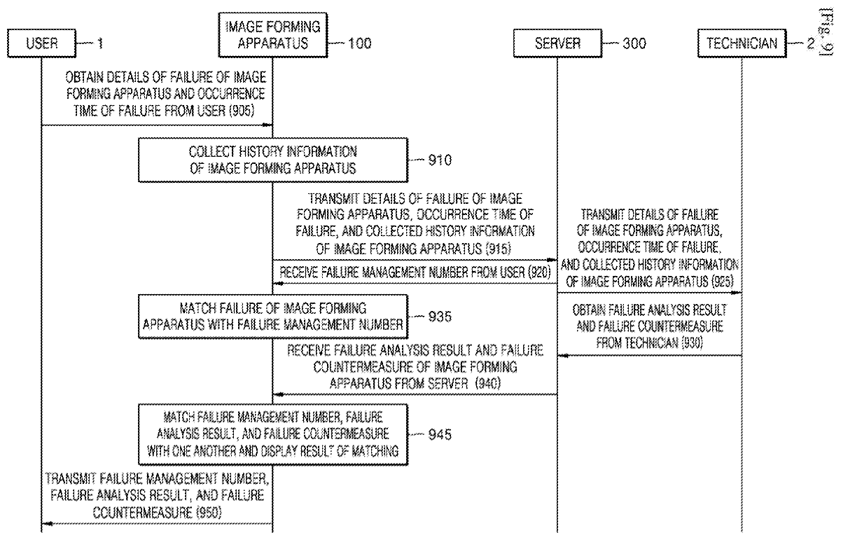

FIG. 8 is a flowchart of a second reporting method according to an example.

Operations 810, 830, and 840 of FIG. 8 may be a portion of operation 610 of FIG. 6, operation 820 of FIG. 8 may be a portion of operation 620 of FIG. 6, operation 850 of FIG. 8 may be a portion of operation 630 of FIG. 6, and operation 860 of FIG. 8 may be a portion of operation 640 of FIG. 6.

Referring to FIG. 8, the image forming apparatus 100 may obtain, from the user 1, the input for collecting the history information of the image forming apparatus 100 in operation 810.

In operation 820, the image forming apparatus 100 may up-adjust the collection level of the log to a certain collection level and may start collecting the history information of the image forming apparatus 100.

According to an example, the image forming apparatus 100 may up-adjust the collection level of the log to a certain log level and start collecting the history information of the image forming apparatus 100, in response to the obtainment of, from the user 1, the input for collecting the history information of the image forming apparatus 100.

Alternatively, in response to the starting of the input of the user 1 for making the failure reappear, the image forming apparatus 100 may up-adjust the collection level of the log to the certain collection level and start collecting the history information of the image forming apparatus 100.

In operation 830, the image forming apparatus 100 may obtain, from the user 1, the input of making the failure reappear.

In operation 840, the image forming apparatus 100 may obtain the comment about the failure from the user 1.

In operation 850, the image forming apparatus 100 may transmit the comment about the failure obtained from the user 1 and the collected history information of the image forming apparatus 100 to the server 300.

In operation 860, the image forming apparatus 100 may receive the failure management number, the failure analysis result, and the failure countermeasure of the image forming apparatus 100 from the server 300.

In operation 870, the image forming apparatus 100 may control the failure management number, the failure analysis result, and the failure countermeasure to be matched with one another and displayed.

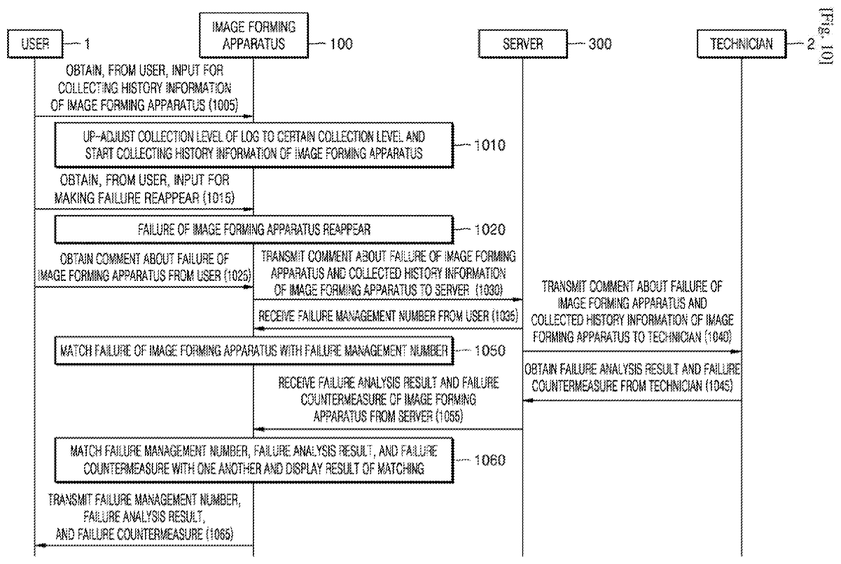

FIG. 9 is a flowchart illustrating operations of a user, an image forming apparatus, a server, and a technician when a first reporting method is performed according to an example.

FIG. 9 is an example of the first reporting method of FIG. 7 via operations of the user 1, the image forming apparatus 100, the server 300, and the technician 2.

Referring to FIG. 9, the image forming apparatus 100 may obtain information such as the details of the failure of the image forming apparatus 100 and the occurrence time point of the failure from the user 1 in operation 905.

In operation 910, the image forming apparatus 100 may collect the history information of the image forming apparatus 100.

In operation 915, the image forming apparatus 100 may transmit the information such as the details of the failure of the image forming apparatus 100, the occurrence time point of the failure, and the collected history information of the image forming apparatus 100 to the server 300.

In operation 920, the image forming apparatus 100 may receive the failure management number from the user 300.

In operation 925, the server 300 may transmit the information such as the details of the failure of the image forming apparatus 100, the occurrence time point of the failure, and the collected history information of the image forming apparatus 100 to the technician 2.

In operation 930, the server 300 may obtain the failure analysis result and the failure countermeasure from the technician 2.

In operation 935, the image forming apparatus 100 may match the failure of the image forming apparatus 100 with the failure management number.

In operation 940, the image forming apparatus 100 may receive the failure analysis result and the failure countermeasure of the image forming apparatus 100 from the server 300.

In operation 945, the image forming apparatus 100 may match the failure management number, the failure analysis result, and the failure countermeasure with one another and display a result of the matching.

In operation 950, the image forming apparatus 100 may transmit the failure management number, the failure analysis result, and the failure countermeasure to the user 1.

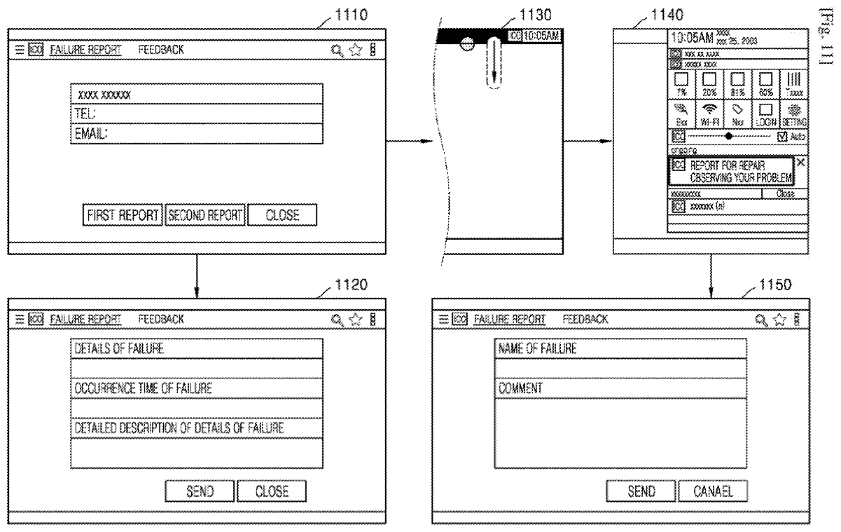

FIG. 10 is a flowchart illustrating operations of a user, an image forming apparatus, a server, and a technician when a second reporting method is performed according to an example.

FIG. 10 shows another example of the second reporting method of FIG. 8, which includes operations of the user 2, the image forming apparatus 100, the server 300, and the technician 2.

Referring to FIG. 10, the image forming apparatus 100 may obtain, from the user 1, an input for collecting the history information of the image forming apparatus 100 in operation 1005.

In operation 1010, the image forming apparatus 100 may up-adjust the collection level of the log to a certain collection level and may start collecting the history information of the image forming apparatus 100.

In operation 1015, the image forming apparatus 100 may obtain, from the user 1, the input of making the failure reappear.

In operation 1020, the failure of the image forming apparatus 100 may reappear based on the failure-reappearing input obtained from the user 1.

In operation 1025, the image forming apparatus 100 may obtain the comment about the failure of the image forming apparatus 100 from the user 1.

In operation 1030, the image forming apparatus 100 may transmit the comment about the failure of the image forming apparatus 100 and the collected history information of the image forming apparatus 100 to the server 300.

In operation 1035, the image forming apparatus 100 may receive the failure management number from the user 300.

In operation 1040, the server 300 may transmit the comment about the failure of the image forming apparatus 100 and the collected history information of the image forming apparatus 100 to the technician 2.

In operation 1045, the server 300 may obtain the failure analysis result and the failure countermeasure from the technician 2.

In operation 1050, the image forming apparatus 100 may match the failure of the image forming apparatus 100 with the failure management number received from the server 300.

In operation 1055, the image forming apparatus 100 may receive the failure analysis result and the failure countermeasure of the image forming apparatus 100 from the server 300.

In operation 1060, the image forming apparatus 100 may match the failure management number, the failure analysis result, and the failure countermeasure with one another and display a result of the matching.

In operation 1065, the image forming apparatus 100 may transmit the failure management number, the failure analysis result, and the failure countermeasure to the user 1.

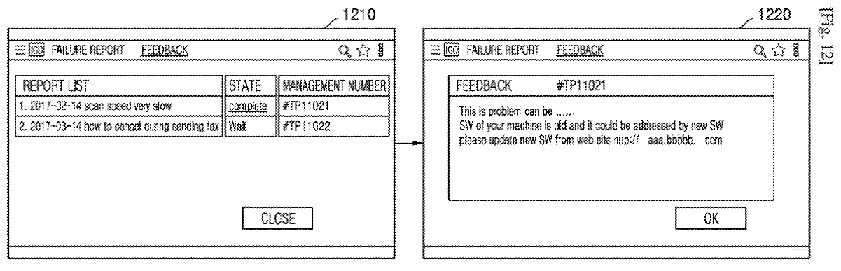

FIG. 11 illustrates UI screen images that show a failure reporting process according to an example.

Referring to FIG. 11, the user 1 may select the first reporting method or the second reporting method in order to report a failure of the image forming apparatus 100 using a UI screen image 1110. The user 1 may write contact information (e.g., a telephone number, an email address, etc.) that is to receive a failure countermeasure of the image forming apparatus 100.

According to an example, when the user 1 selects a “first report” on the UI screen image 1110, the UI screen image 1110 displayed on the screen of the UI device 110 may switch to a UI screen image 1120. As shown in the UI screen image 1120, the user 1 may input information such as “the details of the failure” and “the occurrence time point of the failure” in order to conduct the first report, and may further input “a detailed description of the details of the failure” in order to help the technician 2 to ascertain the failure of the image forming apparatus 100.

According to an example, when the user 1 selects a “second report” on the UI screen image 1110, the UI screen image 1110 displayed on the screen of the UI device 110 may be switched to a UI screen image 1130. An icon “ICO” shown on the right upper end of a UI screen image 1130 may indicate that the history information of the image forming apparatus 100 is being collected to conduct the second report.

When a boundary between a black area and a white area, indicated with a circle at the left upper end of the UI screen image 1130, is dragged downwards, a state-indicating box may appear as in a UI screen image 1140. The state-indicating box may include, for example, a current time, a network connection state (e.g., a Wi-Fi connection state) of the image forming apparatus 100, an “ongoing bar” indicating a currently-being-conducted operation. The ongoing bar or state-indicating box may indicate that the history information of the image forming apparatus 100 is being collected to conduct the second report.

According to an example, when the collection of the history information of the image forming apparatus 100 to conduct the second report is concluded, the UI screen image 1140 displayed on the screen of the UI device 110 may switch to a UI screen image 1150. As shown in the UI screen image 1150, the user 1 may input a “comment” about the failure of the image forming apparatus 100 in order to conduct the second report, and may further input “the name of the failure”.

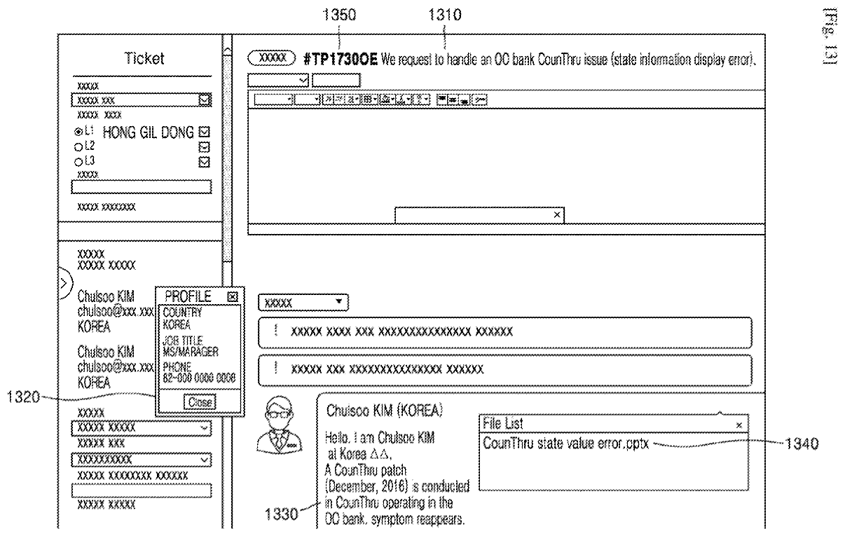

FIG. 12 illustrates UI screen images that display a failure countermeasure according to an example.

Referring to FIG. 12, a UI screen image 1210 may display an item “report list” of the user 1. The UI screen image 1210 may display an item “state” indicating whether a failure countermeasure has been transmitted to the image forming apparatus 100 and an item “failure management number”, together with the item “report list” including the occurrence date of a failure of the image forming apparatus 100 and the information such as the details of the failure.

According to an example, when the user 1 selects a failure management number “# TP11021” on the UI screen image 1210, the UI screen image 1210 displayed on the screen of the UI device 110 may switch to a UI screen image 1220. The UI screen image 1220 may display a failure countermeasure, namely, a feedback, of the image forming apparatus 100.

In an example, the UI screen image 1220 may display a failure analysis result indicating “The failure of the image forming apparatus 100 occurred because the software of the image forming apparatus 100 is old” and a failure countermeasure indicating “the failure of the image forming apparatus 100 can be addressed by updating the software from “a website http://aaa.bbbbb.com”, in relation to the failure management number “# TP11021”.

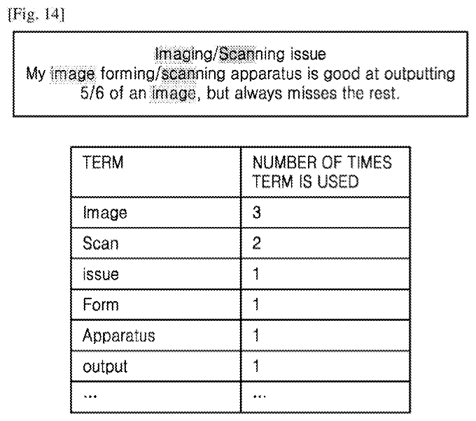

FIG. 13 illustrates a UI screen image of a server according to an example.

Referring to FIG. 13, the server 300 may receive the information about the failure of the image forming apparatus 100 and the collected history information of the image forming apparatus 100 from the image forming apparatus 100.

Referring to a UI screen image of the server 300 of FIG. 13, it may be seen that a comment 1330 about a failure of the image forming apparatus 100 written by a user Chulsoo KIM is displayed and a file “CounThru state value error. pptx” is attached as information 1340 of the failure of the image forming apparatus 100. Moreover, a failure name “00 bank CounThru issue (state information display error)” 1310 and a failure management number “# TP17300E” 1350 may be displayed. Also, a user profile 1320 including information such as a position, contact information, a nationality of the user Chulsoo KIM, or the like may be displayed.

According to an example, the technician 2 may input a failure analysis result and a failure countermeasure of the failure management number “# TP17300E” 1350 to the server 300, by referring to the file name “00 bank CounThru issue (state information display error)” 1310, the comment 1330 of the failure, and the information 1340 of the failure displayed on the UI screen image of the server 300. The technician 2 may immediately notify the user Chulsoo KIM of the failure analysis result and the failure countermeasure of the image forming apparatus 100 by using the user profile 1320.

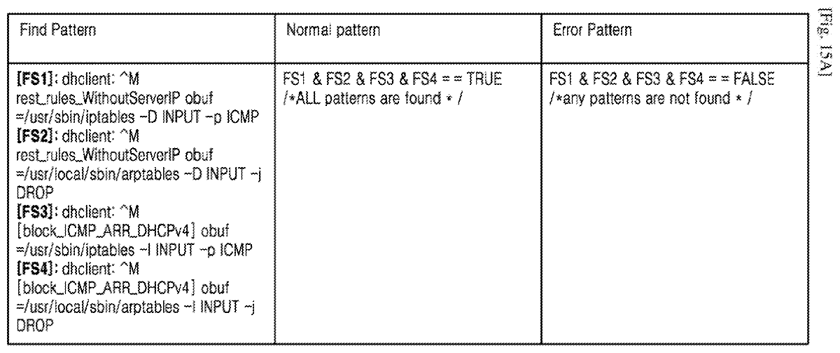

FIG. 14 illustrates an example in which a server analyzes information about a failure input by a user, based on keywords.

Referring to FIG. 14, the server 300 may analyze information about a failure of the image forming apparatus 100 input by the user 1 to the image forming apparatus 100, based on the numbers of times terms are used. In more detail, the server 300 may analyze information such as details of the failure of the image forming apparatus 100 and a comment about the failure input by the user 1 to the image forming apparatus 100, based on the numbers of times terms are used.

For example, the server 300 may detect the numbers of times terms are used by analyzing information “Imaging/Scanning issue. My image forming/scanning apparatus is good at outputting 5/6 of an image, but always misses the rest” about a failure of the image forming apparatus 100 input by the user 1 to the image forming apparatus 100.

According to an example, the server 300 may detect the top two keywords most frequently used from among the terms in the information about the failure of the image forming apparatus 100. When searching for a failure countermeasure with regard to the image forming apparatus 100, the server 300 may preferentially search for a log pattern including the top two keywords most frequently used from among the terms in the information about the failure. The server 300 may reduce a time period during which the failure countermeasure for the image forming apparatus 100 is searched for by preferentially searching for a log pattern including the top two keywords most frequently used from among the terms in the information about the failure.

In an example, referring to FIG. 14, to search for a failure countermeasure for the image forming apparatus 100, the server 300 may preferentially search for a log pattern including “Image” and “Scan”, which are the top two keywords most frequently used from among the terms in the information about the failure.

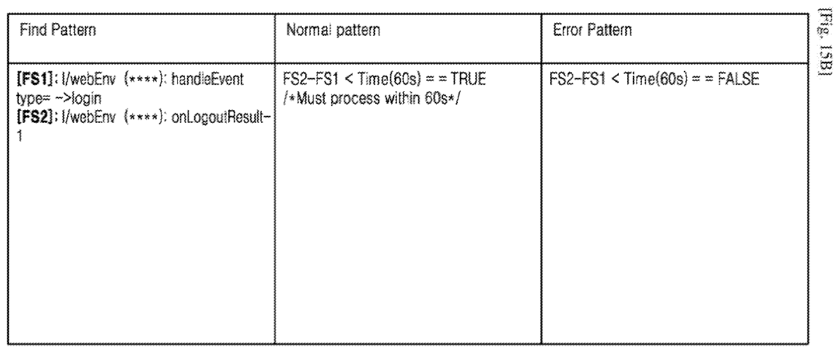

FIGS. 15A and 15B are tables illustrating an example in which a server analyzes a log pattern included in history information of an image forming apparatus.

Referring to FIG. 15A, a case where four log patterns FS1, FS2, FS3, and FS4 are all included in the history information of the image forming apparatus 100 may correspond to a normal state. When any of the four log patterns FS1, FS2, FS3, and FS4 is not included in the history information of the image forming apparatus 100, the server 300 may determine that the image forming apparatus 100 has a failure.

Referring to FIG. 15B, a case where a time difference between time points when two log patterns FS1 and FS2 are processed, respectively, is less than 60 seconds may correspond to a normal state. When the time difference between the time points when the two log patterns FS1 and FS2 are processed, respectively, is equal to or more than 60 seconds, the server 300 may determine that the image forming apparatus 100 has a failure.

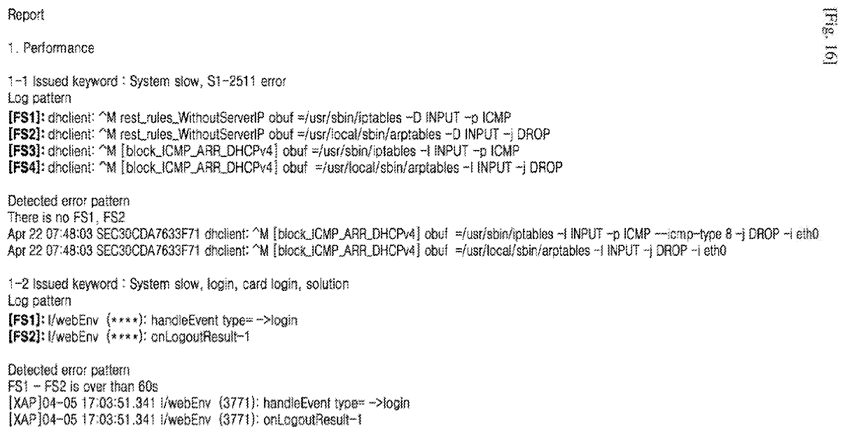

FIG. 16 illustrates a result obtained by a server analyzing a failure of an image forming apparatus according to an example.

Referring to FIG. 16, a report shows issued keywords and detected error patterns in relation to a failure of the image forming apparatus 100. In an example, Performance 1-1 in the report of FIG. 16 indicates that, because the issued keywords are “system slow, and S1-2511 error” and log patterns FS1 and FS2 are not detected, the image forming apparatus 100 experiences a failure.

In an example, Performance 1-2 in the report of FIG. 16 indicates that, because the issued keywords are “system slow, login, card login, and solution” and a time difference between the time points when the log patterns FS1 and FS2 are processed is equal to or more than 60 seconds, the image forming apparatus 100 experiences a failure.

The technician 2 may analyze the failure of the image forming apparatus 100 by referring to the report of FIG. 16.

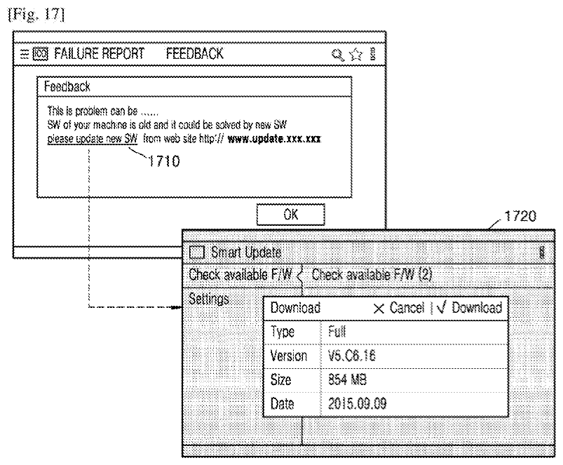

FIG. 17 illustrates an example in which a server transmits a failure handling method.

Referring to FIG. 17, when a failure occurs in the image forming apparatus 100 because the software thereof is old, the server 300 may transmit, to the image forming apparatus 100, a failure countermeasure including a hyperlink 1710 connected to a site for upgrading the software of the image forming apparatus 100. When the user 1 clicks or touches the hyperlink 1710 connected to a site for upgrading the software of the image forming apparatus 100, the screen of the UI device 110 may switch to a UI screen image 1720.

According to another example, the server 300 may transmit, to the image forming apparatus 100, a failure countermeasure including a hyperlink connected to a representational state transfer (REST) Application Programming Interface (API) for changing setting values of the image forming apparatus 100. When the user 1 clicks or touches the hyperlink connected to the REST API, the image forming apparatus 100 may be updated while the setting values of the image forming apparatus 100 are being changed.

The above-described failure reporting methods can be written as computer programs and can be implemented in general-use digital computers that execute the programs using a computer readable recording medium. Examples of the computer-readable recording medium may include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, a magnetic tape, a floppy disk, a magneto-optical data storage device, an optical data storage device, a hard disk, a solid-state disk (SSD), and any device capable of storing an instruction or software, related data, a data file, and data structures and providing the instruction or software, the related data, the data file, and the data structures to a processor or a computer such that the processor or the computer execute the instruction.

Although the above examples of the disclosure have been disclosed for illustrative purposes, one of ordinary skill in the art will appreciate that diverse variations and modifications are possible, without departing from the spirit and scope of the disclosure. Thus, the above examples should be understood not to be restrictive but to be illustrative, in all aspects. For example, respective elements described in an integrated form may be dividedly used, and the divided elements may be used in a state of being combined.

While one or more examples have been described with reference to the figures, it will be understood by those of ordinary skill in the art that various changes in form and details may be made therein without departing from the spirit and scope as defined by the following claims.

1. An image forming apparatus capable of generating a failure report, the image forming apparatus comprising:
a user interface device to obtain information about a failure of the image forming apparatus which is undetectable by the image forming apparatus, according to an input of a user;
a controller to collect history information of the image forming apparatus, based on the information about the failure; and
a communicator to transmit the information about the failure and the collected history information to a server and receive a failure countermeasure for the image forming apparatus from the server.

2. The image forming apparatus of claim 1, wherein the user interface device obtains the information about the failure and an occurrence time of the failure from the user.

3. The image forming apparatus of claim 2, wherein the controller collects at least one of a log, a user interface manipulation screen recorded image, or network information of the image forming apparatus within a certain time period from the occurrence time of the failure.

4. The image forming apparatus of claim 1, wherein the user interface device obtains, from the user, an input for making the failure reappear.

5. The image forming apparatus of claim 4, wherein the controller collects at least one of a log, a user interface manipulation screen recorded image, or network information of the image forming apparatus while the failure is reappearing according to the input for making the failure reappear.

6. The image forming apparatus of claim 5, wherein the controller up-adjusts a collection level of the log to a certain collection level in response to a start of the input for making the failure reappear.

7. The image forming apparatus of claim 3, wherein the controller adjusts an up-adjusted collection level of the log to a collection level before a collection level of the log is up-adjusted, in response to a termination of the input for making the failure reappear.

8. The image forming apparatus of claim 4, wherein the user interface device obtains a comment about the failure from the user.

9. The image forming apparatus of claim 1,
wherein the controller controls a failure management number corresponding to the collected history information and the failure countermeasure to be matched with each other and displayed, and
wherein the failure management number and the failure countermeasure are received from the server.

10. A failure reporting method performed by an image forming apparatus, the failure reporting method comprising:
obtaining information about a failure of the image forming apparatus which is undetectable by the image forming apparatus, according to an input of a user;
collecting history information of the image forming apparatus, based on the information about the failure;
transmitting the information about the failure and the collected history information to a server; and
receiving a failure countermeasure for the image forming apparatus from the server.

11. The failure reporting method of claim 10, wherein the obtaining of the information about the failure comprises obtaining the information about the failure and an occurrence time of the failure from the user.

12. The failure reporting method of claim 11, wherein the collecting of the history information comprises collecting at least one of a log, a user interface manipulation screen recorded image, or network information of the image forming apparatus within a certain time period from the occurrence time of the failure.

13. The failure reporting method of claim 10, wherein the obtaining of the information about the failure comprises obtaining, from the user, an input for making the failure reappear.

14. The failure reporting method of claim 13, wherein the collecting of the history information comprises collecting at least one of a log, a user interface manipulation screen recorded image, or network information of the image forming apparatus while the failure is reappearing according to the input for making the failure reappear.

15. The failure reporting method of claim 14, wherein the collecting of the history information further comprises up-adjusting a collection level of the log to a certain collection level in response to a start of the input for making the failure reappear.

16. The failure reporting method of claim 15, wherein the collecting of the history information further comprises adjusting the up-adjusted collection level of the log back to a collection level before a collection level of the log is up-adjusted, in response to a termination of the input for making the failure reappear.

17. The failure reporting method of claim 13, wherein the obtaining of the information about the failure further comprises obtaining a comment about the failure from the user.

18. The failure reporting method of claim 10, further comprising:
controlling a failure management number corresponding to the collected history information and the failure countermeasure to be matched with each other and displayed,
wherein the failure management number and the failure countermeasure are received from the server.

19. A non-transitory computer-readable recording medium having recorded thereon instructions for a failure reporting method performed by an image forming apparatus, the non-transitory computer-readable recording medium comprising:
instructions for obtaining information about a failure of the image forming apparatus which is undetectable by the image forming apparatus, according to an input of a user;
instructions for collecting history information of the image forming apparatus, based on the information about the failure;
instructions for transmitting the information about the failure and the collected history information to a server; and
instructions for receiving a failure countermeasure for the image forming apparatus from the server.
